(19) United States
(12) Patent Application Publication
(10) Pub. No.: US 2010/0049405 A1
(43) Pub. Date: Feb. 25, 2010

(54) AUXILIARY VIDEO WARNING DEVICE FOR VEHICLES

(76) Inventor: Shih-Hsiung Li, Taipei (TW)

Correspondence Address: RABIN & Berdo, PC, 1101 14TH STREET, NW, SUITE 500, WASHINGTON, DC, 20005, US

(21) Appl. No.: 12/476,466

(22) Filed: Jun. 2, 2009

(30) Foreign Application Priority Data
Aug. 22, 2008 (TW) 097132041

(51) Int. Cl. G06F 7/00

(52) U.S. Cl. 701/45

(57) ABSTRACT

An auxiliary video warning device for vehicles has multiple video extracting elements for extracting video images around a vehicle. Using a video switch unit, selected video signals are sent to a vehicle display to enlarge the driver's view. A video identifying unit analyzes images outside the vehicle from a certain perspective, determining whether there is any moving object and whether its distance is changing. The result is used to automatically set off an alarm to notify the driver. During the motion of the vehicle, if any vehicle in a neighboring lane changes lanes or crosses lines illegally, an alarm is sent to the driver for better safety.

### BACKGROUND OF THE INVENTION

1. Field of the Invention

The invention relates to an auxiliary video warning device for vehicles and, in particular, to an aided warning device that monitors neighboring vehicles during its motion. If any neighboring vehicle changes lanes or illegally crosses lines, the warning device sets off an alarm to notify the driver.

2. Description of Related Art

When a driver drives a vehicle, the road condition in front of the vehicle is usually judged by the driver. This basically has no problem if the visual field is wide and clear. However, when the vehicle approaches a turn or moves out of a narrow alley, the driver usually does not have a good view of the environment. If another vehicle comes perpendicular to the current vehicle, it is likely to have a traffic accident.

With reference to FIG. 7, when the current vehicle A comes out of an alley, the visual fields in the left-front (L), right-front (R), and direct-front (F) directions are shown in FIG. 8. In such a situation, the driver of vehicle A apparently cannot notice another vehicle approaching from a perpendicular direction.

Moreover, when the vehicle backs on a road with a large angle or backs out from a narrow parking slot, there is also a danger due to the above-mentioned factor. As shown in FIG. 9, as vehicle A backs out from a parking slot, the visual fields in the left-rear (L), right-rear (R), and direct-rear (F) directions are given in FIG. 10. The driver of vehicle A still cannot notice another vehicle approaching from a perpendicular direction.

To solve the above-mentioned problems, U.S. application Ser. No. 10/788,826 effectively enlarges the visual field of the driver. It is featured in that the head and tail lights are installed with a video extracting element, respectively. Two video switch units connect to two display devices on both sides of the driver seat. The two video switch units are controlled by one control unit. In addition to detecting the reverse gear and the turning signals, the control unit also connects to a speed detector.

When the vehicle proceeds at a certain speed, the control unit sends images extracted by the video extracting element in the head light to the display devices via the video switch unit, providing a larger visual field in the front. If the vehicle runs faster than the speed limit, the display device is switched to play the images extracted by the video extracting elements in the tail light. The driver can thus check the condition in the back. Since the video extracting elements inside the lights face opposite directions, they can effectively enlarge the visual field of the driver.

Although the above-mentioned application can improve driving safety by enlarging the visual field, it cannot solve all the possible problems on the road. There are simply too many factors that may cause traffic accidents.

For example, with reference to FIG. 11, vehicles are supposed to run between lane dividers. However, the vehicles may deviate if the driver is not careful enough as shown in FIG. 12 that the vehicle runs towards the right lane divider. In this case, the vehicle may have a collision with another vehicle in the neighboring lane. On the other hand, even if the vehicle A follows its lane, a collision is still possible if another vehicle in the neighboring lane suddenly change lanes or cross the line. the normal driving condition is shown in FIG. 13 whereas the vehicle on the right-hand side of FIG. 14 suddenly crosses the line. In such situations, the previously mentioned invention is still of no use.

### SUMMARY OF THE INVENTION

In view of the foregoing, an objective of the invention is to provide an auxiliary video warning device for vehicles that does not only enlarge the driver's visual field, but also automatically determines and notifies the driver by sounds when there is a potential danger using a video identification technique.

To achieve the above-mentioned objective, the disclosed auxiliary video warning device for vehicles includes:

multiple video extracting elements for extracting images in the left front, right front, left rear, right rear, and direct rear of the vehicle respectively;

a video identifying unit connected with the video extracting elements and identifying moving objects and abnormal conditions in the extracted images;

a video switch unit connected with the video extracting elements;

a control unit connected with the video identifying unit and the video switch unit;

an alarm controlled by the control unit to notify the driver by sound and/or light; and

a vehicle display connected to the video switch unit.

Using the above-mentioned design, when the vehicle proceeds in a narrow alley, some video extracting units installed on the front (left and right fronts) enables the driver to watch out for any vehicle approaching in a perpendicular direction. Moreover, the video identifying unit can automatically identify moving objects and notify the driver by sounds. Therefore, the invention can effectively increase the driving safety.

When the vehicle backs on a road with a large turning angle or backs out from a narrow parking slot, some video extracting elements are installed on the tail (left rear, right rear, and direct rear) to enable the driver to notice any incoming vehicle in the back. The video identifying unit can automatically identify moving objects and notify the driver by sounds.

Moreover, if the vehicle crosses lines during its motion, the positions of lane dividers change in the extracted images. Once the video identifying unit discovers that a lane divider is too close to the vehicle, it automatically notifies the driver.

If a neighboring vehicle suddenly changes lanes (or suddenly accelerate from the back), its image in the extracted images becomes larger. When the video identifying unit discovers that the vehicle size in the images exceeds a safety range or its size increases by a huge amount in a short time, then the monitored vehicle is marked on the image. At the same time, a warning sound is sent out to notify the driver.

When the vehicle moves forwards, if the video identifying unit analyzes and finds that the image of vehicle behind extracted by the video extracting elements in the back suddenly becomes larger, the monitored vehicle is marked on the screen. At the same time, the driver is notified by a voice or alarming sound.

The control unit can further connect to a speed detector. When the speed detector detects that the vehicle speed is lower than a certain value, the control unit starts the video extracting elements in the front. When the vehicle speed is higher than the threshold value, it switches to the video extracting elements in the back for the driver to monitor the road condition in the back.

The control unit can further detect the state of the reverse gear. It can also connect with a backing radar.

### BRIEF DESCRIPTION OF THE DRAWINGS

FIG. 1 is a block diagram of the invention;

FIG. 2 is a schematic view of installing the video extracting elements at various locations on a vehicle;

FIGS. 3A to 3D are schematic views showing how the invention monitors road conditions;

FIGS. 4 to 6 are schematic views of monitoring ranges of the invention;

FIG. 7 is a schematic view showing when a vehicle approaches a crossroad;

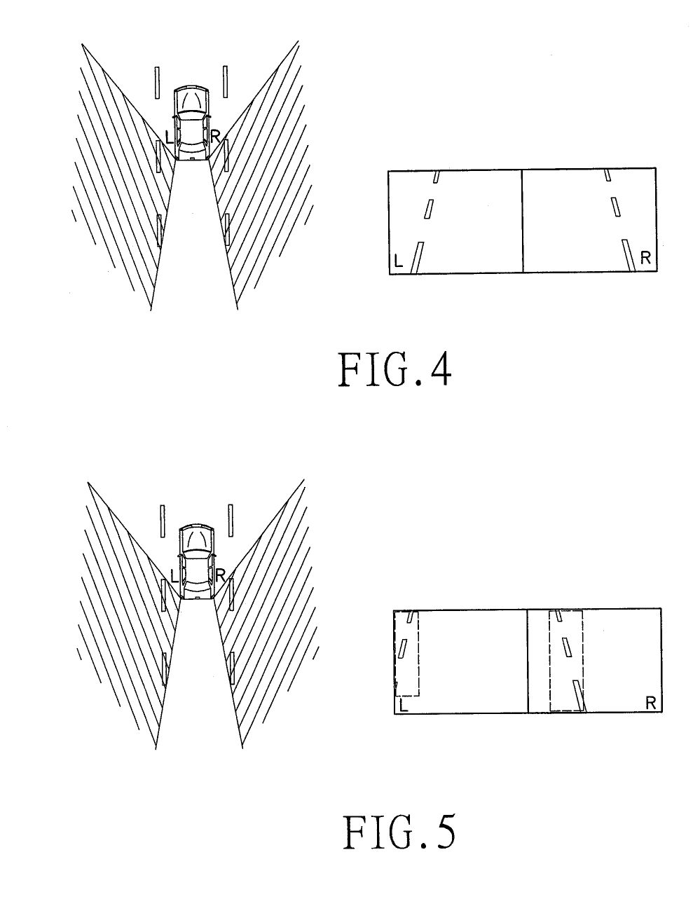

FIG. 8 is a schematic view of the driver's visual field as the vehicle approaches a crossroad;

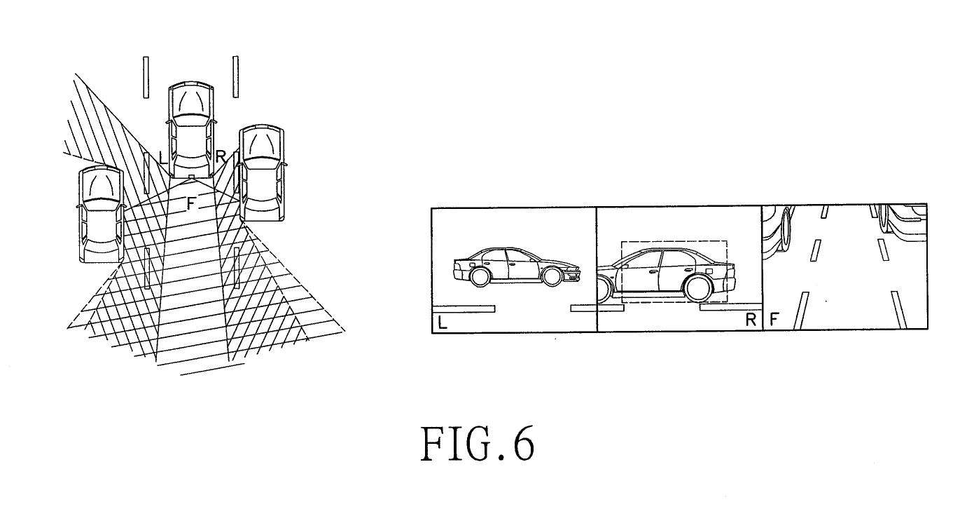

FIG. 9 is a schematic view showing that a vehicle backs out of a parking slot;

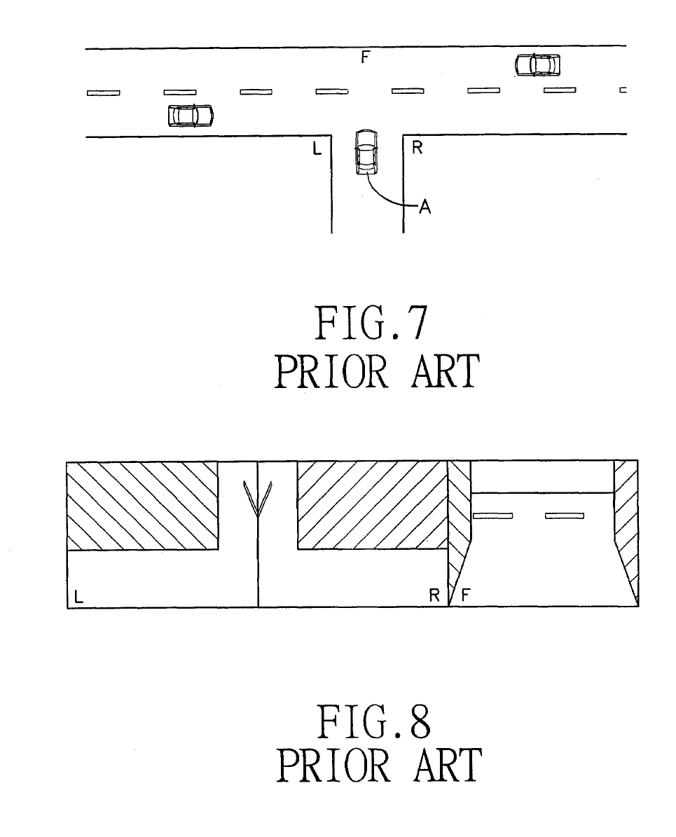

FIG. 10 shows the driver's visual field when a vehicle backs out of a parking slot;

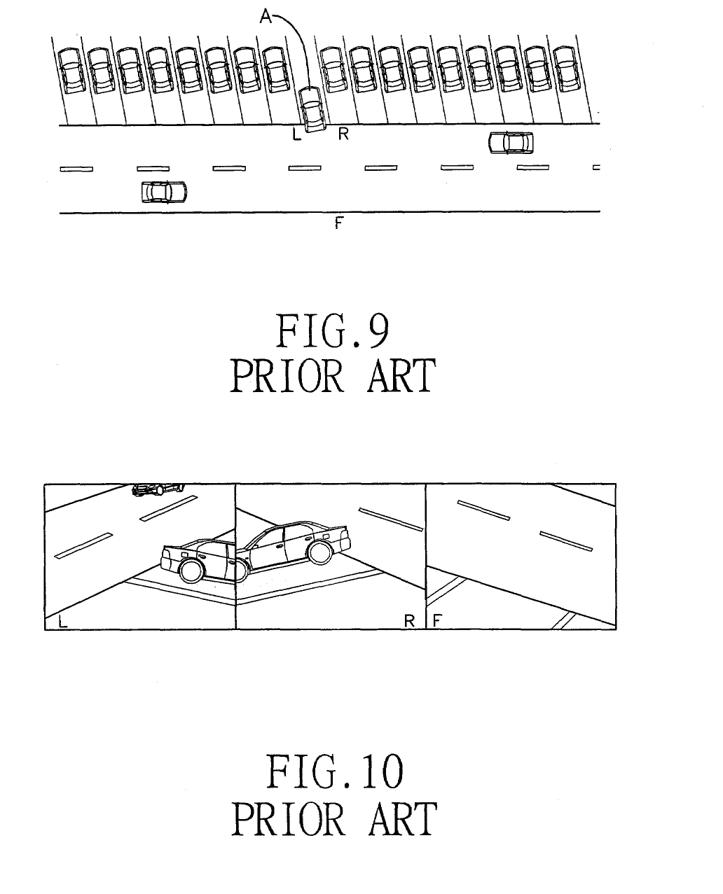

FIGS. 11 to 14 are schematic views showing the vehicle moving on a road and its relations to other vehicles.

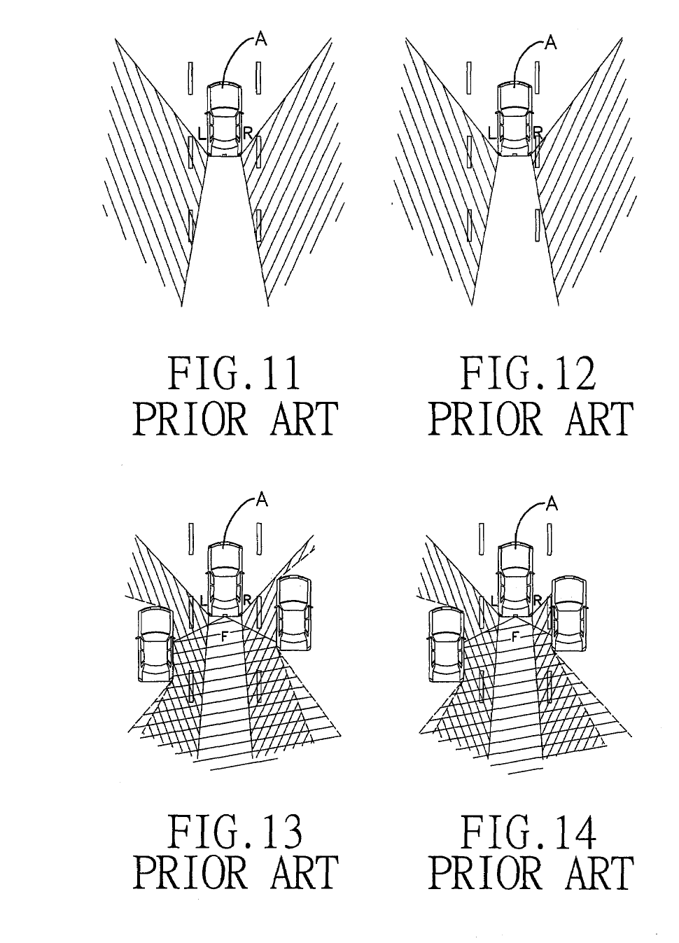

### DETAILED DESCRIPTION OF THE PREFERRED EMBODIMENT

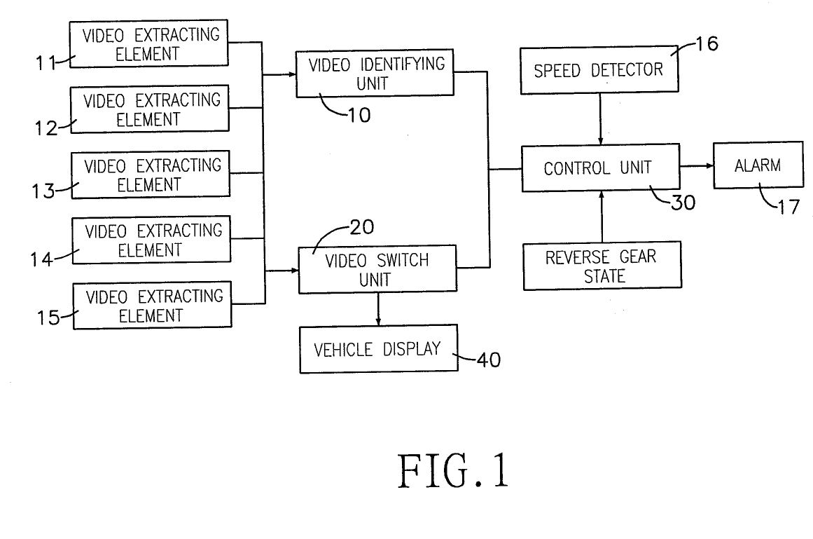

With reference to FIG. 1, a preferred embodiment of an auxiliary video warning device for vehicles in accordance the invention comprises multiple video extracting elements 11 to 15, a video identifying unit 10, a video switch unit 20, a control unit 30, a vehicle display 40, and an alarm 17.

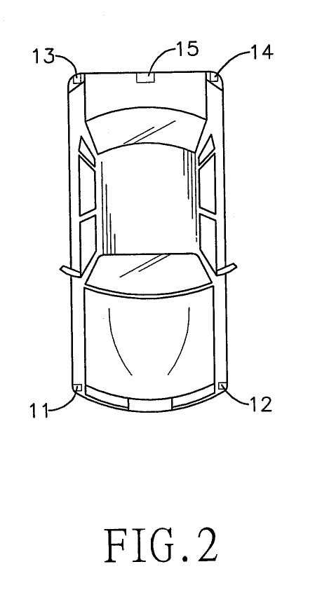

With reference to FIG. 2, the video extracting elements 11 to 15 are installed in the left front, right front, left rear, right rear, and direct rear of the vehicle, respectively. The video extracting elements 11 to 14 in the left front, right front, left rear, and right rear are disposed slightly toward the sides for extracting images to the left front, right front, left rear, and right rear of the vehicle. The video extracting element in the direct rear extracts images directly behind the vehicle. Each of the video extracting elements can be a CCD or CMOS image sensor.

The video switch unit 20 is connected between the video extracting elements 11 to 15 and the vehicle display 40 and is controlled by the control unit 30 to select one of the video extracting elements 11 to 15 and to play the extracted images on the vehicle display 40.

The video identifying unit 10 has multiple video input interfaces (not shown). Each of the video input interfaces is connected to a corresponding video extracting element 11 to 15 for analyzing the extracted images. The video identifying unit 10 determines and analyzes whether there is a moving object in the image and whether the size of the moving object changes. The analysis result is sent back to the control unit 30. The video identifying unit 10 also connects to the control unit 30. The control unit 30 controls the video identifying unit 10 to select and process the images of one of the video extracting elements 11 to 15.

The control unit 30 uses the information of vehicle speed, moving direction, and making a turn or not to determine whether to switch the video switch unit 20 and which video extracting unit 10 to analyze. In this embodiment, the control unit 30 obtains the states of the reverse gear and the turning signal light from the internal system of vehicle as the references of the video switch unit 20 and the video identifying unit 10. The control unit 30 is further connected with a speed detector 16 that detects the driving speed of the vehicle as a reference for deciding which video extracting element to use. Taking the vehicle speed 10 km/h as a threshold value, when the vehicle speed is lower than the threshold value, it probably means that the vehicle is approaching a crossroad and slowing down. In this case, the control unit 30 controls the video identifying unit 10 to analyze the images extracted in the front (left front and right front). If there is any abnormal condition in the images, the video identifying unit 10 sends the information to the control unit 30, and the control unit 30 sends out a warning via the alarm 17. Likewise, if the vehicle speed is lower than the threshold and the control unit 30 detects that the vehicle is backing, the control unit 30 controls the video identifying unit 10 to connect to the video extracting elements in the back (left rear, right rear and direct rear). If there is any abnormal condition in the images, the video identifying unit 10 sends the information to the control unit 30 and the control unit 30 sends out a warning via the alarm 17.

When the vehicle speed is higher than the threshold value and the vehicle is not backing, then the control unit 30 controls the video identifying unit 10 to connect with the video extracting elements in the left rear, right rear, and direct rear for analyzing images thereof. When any vehicle approaches the current vehicle from the left rear, right rear, or direct rear or the current vehicle crosses a line, a warning is also sent out to notify the driver.

Moreover, the vehicle display 40 can be disposed on the dashboard in front of the driver seat and is connected to the output terminal of the video switch unit 30 in order to display images selected by the video switch unit 30.

The alarm 17 is connected to the output terminal of the control unit 30 for sending warnings in the forms of sound and/or light.

According to the above description, the invention has video extracting elements in the front and back of a vehicle. They are all connected with the video identifying unit 10. The video identifying unit 10 analyzes the extracted images to determine if there is any abnormal condition such as objects moving perpendicular to the current vehicle, a fasting approaching object, line crossing, etc, and then warns the driver under the control of the control unit 30. The video extracting elements in the front and back are connected with the vehicle display 40 via the video switch unit 20. When there is a moving object in the extracted image, the moving object becomes larger in size, or the vehicle crosses a line, the control unit 30 marks the moving object on the image in a clear way (e.g., using a flashing frame) besides setting off the alarm 17.

The steps for the video identifying unit 10 to determine a vehicle that is approaching or crossing a line is as follows.

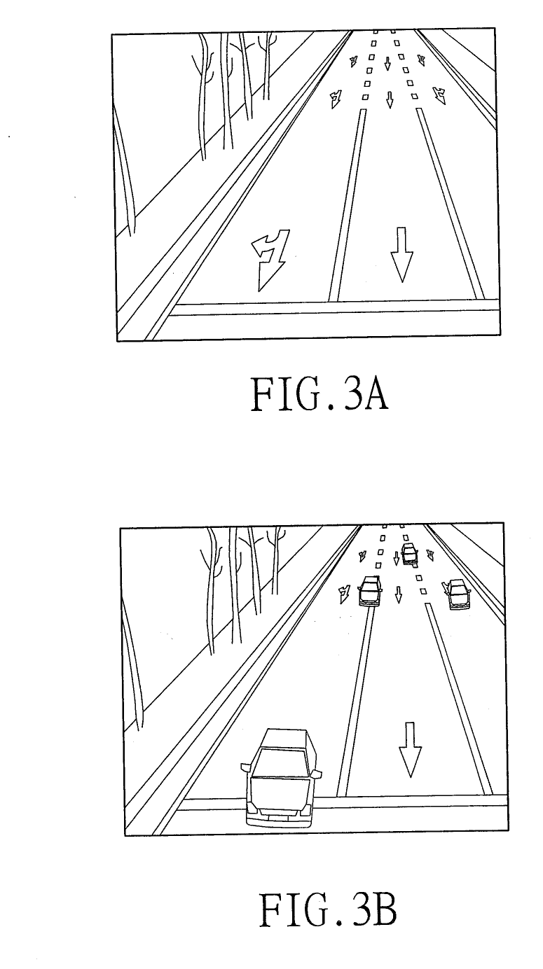

With reference to FIGS. 3A to 3D, the video identifying unit 10 uses the following principle to position the profiles of surrounding vehicles.

When the position of a video extracting element 11 to 15 remains unchanged, the background of captured images do not vary much during a short time. In contrast, a moving object in the image changes more. Therefore, it is possible to find out the moving object by comparing the difference between consecutive images. The vehicle positioning process is shown in FIGS. 3A to 3D.

FIG. 3A shows the road condition reconstructed by the video identifying unit 10 using statistical characters. FIG. 3B shows the road condition when the extracted images have a moving vehicle. Comparing FIGS. 3A and 3B, an image as shown in FIG. 3C can be obtained, where the white part is the moving object after computations. Moreover, after removing the part that does not match with a vehicle, the profile, size (dashed frame), and position of other moving vehicles in FIG. 3D can be obtained. FIGS. 3A to 3D monitor vehicles from behind as an example. When a positioned vehicle approaches the current vehicle at a high speed, the vehicle size in the images increases rapidly. In view of this, the control unit 30 sets off the alarm 17 to notify the driver that the vehicle may collide from behind.

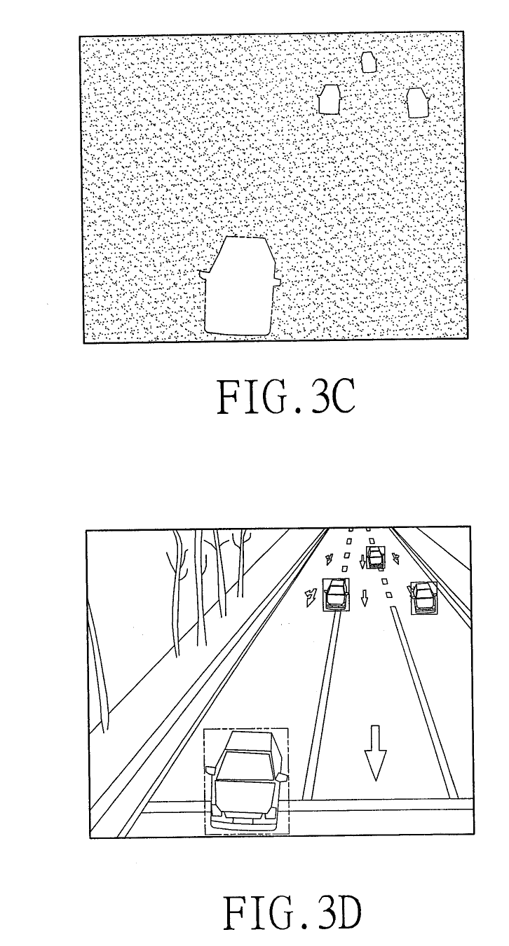

The images extracted by the video extracting elements in the left front and right front of the vehicle can be used to monitor whether the current vehicle is proceeding normally. The display image in FIG. 4 shows that the current vehicle moves normally in the correct lane. The video identifying unit 10 also simultaneously lock the positions of lane markings in the images. With reference to FIG. 5, once the current vehicle deviate from its lane, the positions of the lane markings change. The position-changed lane markings is then marked by a dashed rectangle on the vehicle display 40. At the same time, the driver is notified in the form of sound or light via the alarm 17.

With reference to FIG. 6, the images extracted by the video extracting element 11 to 14 in the left front, right front, left rear, and right rear of the vehicle are used to monitor the moving states of vehicles in neighboring lanes. When a vehicle in the neighboring lane suddenly approaches, the size of moving object (vehicle) in the images extracted by the video extracting elements rapidly increases and the relative positions of the lane dividers change as well. Therefore, the invention can determine whether vehicles in neighboring lanes are about to change lanes or cross lines. In addition to marking the monitored vehicles on the vehicle display 40, the invention also uses the alarm 17 to send out warnings in the form of sound or light to notify the driver.

Another function of the video extracting elements in the front and back of the vehicle is to enlarge the visual field of the driver. The video extracting elements in the front are installed on the left front and right front. When the head of the vehicle approaches a crossroad, the driver immediately knows the conditions at the cross. With the video extracting elements installed in the back, the driver can know the conditions in the back when the vehicle backs out of a parking slot or narrow alley.

In summary, the invention uses the video extracting elements installed in the front and back of the vehicle to monitor conditions around the vehicle, with the help of the video identifying technique. This can prevent many potential traffic accidents.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An auxiliary video warning device for a vehicle, the warning device comprising:
multiple video extracting elements for extracting images in the left front, right front, left rear, right rear, and direct rear of the vehicle respectively;
a video identifying unit connected with the video extracting elements and identifying moving objects and abnormal conditions in the extracted images;
a video switch unit connected with the video extracting elements;
a control unit connected with the video identifying unit and the video switch unit;
an alarm controlled by the control unit to notify the driver by sound and/or light; and
a vehicle display connected to the video switch unit.

2. The auxiliary video warning device as claimed in claim 1, wherein the video identifying unit checks the images extracted by the video extracting elements in the right front and right rear or left front and left rear, determining whether there is any moving vehicle in corresponding neighboring lane or the size of the moving object rapidly increases.

3. The auxiliary video warning device as claimed in claim 2, wherein the video identifying unit checks the images extracted by the video extracting element in the direct rear of the vehicle, and determines whether there is any moving vehicle behind the vehicle or the size of the moving object rapidly increases.

4. The auxiliary video warning device a vehicle as claimed in claim 3, wherein the control unit is connected with a speed detector to obtain a vehicle speed.

5. The auxiliary video warning device as claimed in claim 4, wherein the control unit obtains states from a reverse gear and turning signal lights of the vehicle.

6. The auxiliary video warning device as claimed in claim 5, wherein the alarm sends the warning in the form or sound and/or light.

7. The auxiliary video warning device as claimed in claim 1, wherein the control unit is further connected with a speed detector that detects a driving speed of the vehicle as a reference for deciding which video extracting element to use;
when the vehicle speed is lower than a threshold value and the vehicle is moving forward, the control unit controls the video identifying unit to analyze the images in the left front and right front extracted by the video extracting elements;
when the vehicle speed is lower than a threshold value and the vehicle is backing, the control unit controls the video identifying unit to analyze the images in the left rear, right rear and direct rear extracted by the video extracting elements.
